(19) United States
(12) Patent Application Publication
(10) Pub. No.: US 2023/0222988 A1
(43) Pub. Date: Jul. 13, 2023

(54) METHOD FOR COMPENSATING FOR DIFFERENCE BETWEEN POSITIVE AND NEGATIVE POLARITIES OF DISPLAY PANEL

(71) Applicant: SAMSUNG ELECTRONICS CO., LTD., Suwon-si (KR)

(72) Inventor: Wei ZHANG, Jiangsu Province (CN)

(21) Appl. No.: 17/711,629

(22) Filed: Apr. 1, 2022

(30) Foreign Application Priority Data
Jan. 11, 2022 (CN) 202210028289.2

(51) Int. Cl. G09G 3/36

(52) U.S. Cl. CPC G09G 3/3614; G09G 3/3696; G09G 3/3688; G09G 2310/0291; G09G 2310/08

(57) ABSTRACT

A method for compensating for a difference between positive and negative polarities of a display panel is provided. The display panel is electrically connected to a source driver, and the source driver includes first and second output drivers alternately connected to a same data line in the display panel. The method may include: detecting positive and negative polarity effective voltages of the display panel; adjusting a driver setting of at least one of the first and second output drivers based on the positive and negative polarity effective voltages, to change magnitudes of the positive and/or negative polarity effective voltages; and when the positive and negative polarity effective voltages relative to a common mode voltage are same in absolute value, obtaining an adjusted driver setting and applying the adjusted driver setting to the at least one of the first and second output drivers.

### CROSS-REFERENCE TO RELATED APPLICATION

This application is based on and claims priority under 35 U.S.C. § 119 to Chinese Patent Application No. 202210028289.2, filed on Jan. 11, 2022, in the Chinese Intellectual Property Office, the disclosure of which is incorporated by reference herein in its entirety.

### BACKGROUND

### 1. Field

Embodiments relate to a method for compensating for a difference between positive and negative polarities of a display panel.

### 2. Description of the Related Art

In a liquid crystal display (LCD) device, an image is displayed by a polarity inversion method in which polarities are inverted between adjacent liquid crystal cells and between consecutive frame periods, so that a direct current (DC) offset component of a pixel may be eliminated to prevent deterioration of liquid crystal molecules. In the polarity inversion method, a liquid crystal display device is driven by switching data voltages applied to thin film transistors of pixels. The data voltages include a positive polarity data voltage and a negative polarity data voltage.

### SUMMARY

Embodiments are directed to a method for compensating for a difference between positive and negative polarities of a display panel, the display panel being electrically connected to a source driver, the source driver including a first output driver and a second output driver alternately connected to a same data line in the display panel. The method may include: detecting a positive polarity effective voltage and a negative polarity effective voltage of the display panel; adjusting a driver setting of at least one of the first output driver and the second output driver based on the positive polarity effective voltage and the negative polarity effective voltage, to change magnitudes of the positive polarity effective voltage and/or the negative polarity effective voltage; and when the positive polarity effective voltage and the negative polarity effective voltage relative to a common mode voltage are the same in absolute value, obtaining the adjusted driver setting and applying the adjusted driver setting to the at least one of the first output driver and the second output driver.

Embodiments are directed to a source driver for driving a display panel, the source driver including: a first output driver and a second output driver corresponding to each of a plurality of pixels included in the display panel; and a driver control unit. The driver control unit may be configured to adjust a driver setting of at least one of the first output driver and the second output driver based on a positive polarity effective voltage and a negative polarity effective voltage, to change magnitudes of the positive polarity effective voltage and/or the negative polarity effective voltage. The driver control unit may be configured to apply an adjusted driver setting to the at least one of the first output driver and the second output driver. The adjusted driver setting may be obtained when the positive polarity effective voltage and the negative polarity effective voltage relative to a common mode voltage are the same in absolute value.

### BRIEF DESCRIPTION OF THE DRAWINGS

Features will become apparent to those of skill in the art by describing in detail example embodiments with reference to the attached drawings in which:

FIG. 1 is a block diagram of a display device according to an example embodiment.

FIG. 2 is a circuit diagram showing a pixel in a display panel according to an example embodiment.

FIG. 3 is a structural diagram showing a part of a source driver according to an example embodiment.

FIG. 4 is a flowchart of a method according to an example embodiment.

FIG. 5 is an example of a source driver according to an example embodiment.

FIG. 6 is ab example of the source driver of FIG. 5.

FIG. 7 is an example of a source driver according to another example embodiment.

FIG. 8 is a waveform diagram of an output driver driving a pixel on a display panel.

Throughout the drawings and the detailed description, the same reference numerals will be understood to refer to the same elements, features and structures unless otherwise described or provided. The drawings may not be to scale, and the relative size, proportions, and depiction of elements in the drawings may be exaggerated for clarity, illustration, and convenience.

### DETAILED DESCRIPTION

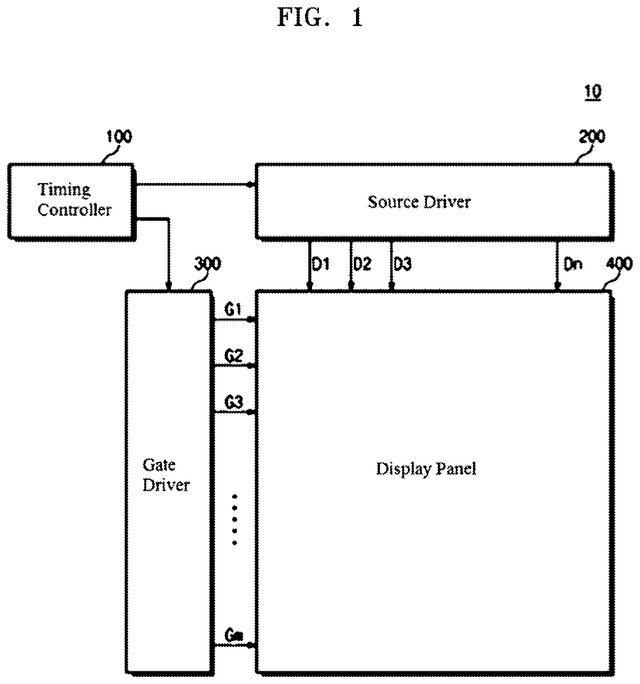

FIG. 1 is a block diagram of a display device according to an example embodiment.

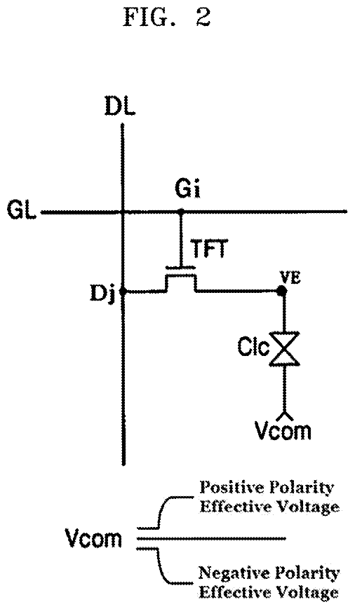

FIG. 2 is a circuit diagram showing a pixel in a display panel according to an example embodiment.

Referring to FIG. 1, a display device 10 may include a timing controller 100, a source driver 200, a gate driver 300, and a display panel 400.

The display device 10 shown in FIG. 1 may be a kind of LCD device. The display device 10 may be a non-emissive display device that can express a grayscale image by being supplied with a voltage. The display device 10 may be an electrochromic display (ECD) device.

The display panel 400 may include gate lines GL, data lines DL which may be arranged to cross the gate lines GL, and pixels which may be disposed at intersections of the gate lines GL and the data lines DL. The display panel 400 may be a matrix type liquid crystal display (LCD) panel.

The timing controller 100 may output image data signals that may be provided from a host (not shown), and adjust them to adapt to timings required by the source driver 200 and the gate driver 300. The timing controller 100 may output control signals to control the source driver 200 and the gate driver 300.

The source driver 200 may include one or more source drivers. The source driver 200 may latch digital image data under the control of the timing controller 100, convert the digital image data into an analog gamma voltage, and generate a data voltage. The source driver 200 may provide data voltages D1 to Dn (n is a positive integer not less than 1) to data lines DL to output image data by driving liquid crystal cells Clc in a target pixel.

The gate driver 300 may generate gate line driving signals G1 to Gm (m is a positive integer not less than 1) for, e.g., sequentially, driving gate lines GL, in response to a control signal output from the timing controller 100.

Referring to FIG. 2, the pixel may be coupled to the gate line GL and the data line DL. The pixel may be implemented to control light transmittance of the liquid crystal cell Clc according to the data voltage Dj (j is an integer greater than or equal to 1 and less than or equal to n), thereby displaying an image with a gray scale. The pixels may be driven by a polarity inversion method.

Each of the pixels may include a liquid crystal cell Clc and at least one transistor. The transistors may be N-type transistors, such as N-type metal-oxide-semiconductor field effect transistors (MOSFETs), or may be P-type transistors, such as P-type MOSFETs. In an implementation, some of the transistors may be N-type MOSFETs, and the remaining transistors may be P-type MOSFETs. In an implementation, each of the pixels may include a liquid crystal cell Clc and one transistor TFT.

The liquid crystal cell Clc may include a first electrode plate connected to the transistor TFT and a second electrode plate receiving a common mode voltage Vcom.

The transistor TFT may be turned on in response to the gate line driving signal Gi (i is an integer greater than or equal to 1 and less than or equal to m) transmitted through the gate line GL to transmit a positive polarity data voltage or a negative polarity data voltage Dj transmitted through the data line DL to the liquid crystal cell Clc. After the transistor TFT is turned on, the higher the data voltage Dj is, that is, the smaller a voltage difference between gate and source electrodes is, the smaller the turn-on current of the transistor TFT is. Therefore, in the case where line time is small, when a thin film transistor in a pixel is respectively applied with a positive polarity data voltage Dj and a negative polarity data voltage Dj having approximately the same gray scale, absolute values of positive and negative polarity effective voltages VE transmitted to a first electrode plate of the liquid crystal cell Clc relative to the common mode voltage may be different. For example, the absolute value of the positive polarity effective voltage VE relative to the common mode voltage may be smaller than the absolute value of the negative polarity effective voltage VE relative to the common mode voltage. Therefore, even when the data line DL transmits the positive polarity data voltage and the negative polarity data voltage Dj having approximately the same gray scale, the actually displayed image may have different gray scales, which may cause display problems such as image sticking, flickering, and the like.

In an implementation, when the transistor is a P-type transistor, the absolute value of the negative polarity effective voltage VE relative to the common mode voltage may be smaller than the absolute value of the positive polarity effective voltage VE relative to the common mode voltage.

To address display issues such as image sticking, flickering, and the like due to short line time, the present example embodiment may adjust a positive polarity output driver (hereinafter referred to as a first output driver) and a negative polarity output driver (hereinafter referred to as a second output driver) in the source driver.

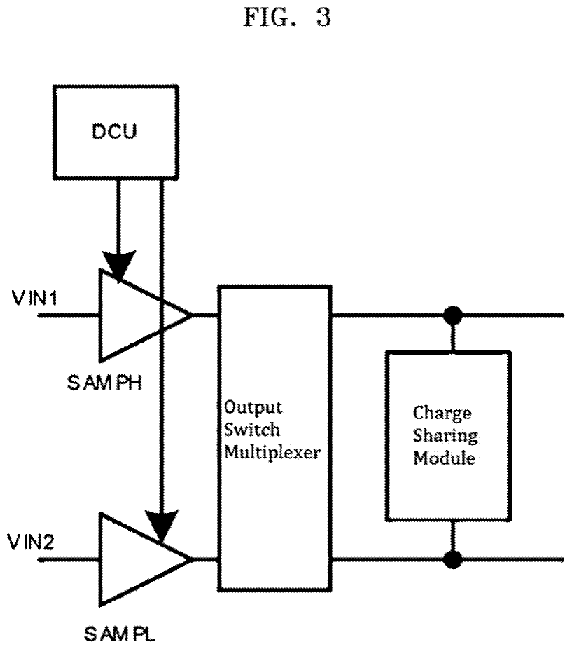

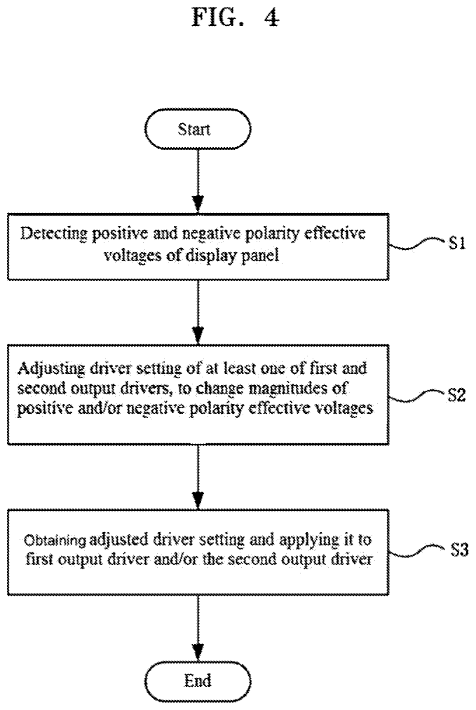

FIG. 3 is a structural diagram showing a part of a source driver according to an example embodiment. FIG. 4 is a flowchart of a method according to an example embodiment.

Referring to FIG. 3, the source driver may include two output drivers SAMPH and SAMPL. In the present example embodiment, when driven by using a polarity switching method, the two output drivers SAMPH and SAMPL are alternately connected to the same data line in the display panel 400, so that one pixel in the display panel 400 may be alternately driven by the two output drivers SAMPH and SAMPL, where the first output driver SAMPH may be used to output data voltages having a positive polarity to the pixel and the second output driver SAMPL may be used to output data voltages having a negative polarity to the pixel. In another implementation, the source driver may include an output switch multiplexer and a charge sharing module connected between the first and the second output drivers SAMPH and SAMPL and the display panel 400, so as to perform polarity inversion between adjacent liquid crystal cells and between consecutive frame periods, which may reduce power consumption and increase an operation speed.

The first output driver SAMPH and the second output driver SAMPL may be implemented as operational amplifiers connected in a buffer manner, although the first output driver SAMPH and the second output driver SAMPL may be implemented in other ways. In an implementation, the first output driver SAMPH and the second output driver SAMPL may be programmable and drivable buffers.

In an implementation, the first output driver SAMPH may transmit a first data voltage to a pixel based on a first input signal VIN1 in an image frame, and the second output driver SAMPL may transmit a second data voltage to the pixel based on a second input signal VIN2 in another image frame, to achieve polarity inversion. In the present example embodiment, the second input signal VIN2 has a polarity opposite to that of the first input signal VIN1 so that the first data voltage and the second data voltage have opposite polarities and the first input signal VIN1 and the second input signal VIN2 respectively correspond to the first data voltage and the second data voltage having the approximately same gray scale. In this case, an absolute value of the second data voltage with respect to the common mode voltage Vcom (i.e., an absolute value of a voltage difference between the second data voltage and the common mode voltage Vcom) is substantially the same as an absolute value of the first data voltage with respect to the common mode voltage Vcom (i.e., an absolute value of a voltage difference between the first data voltage and the common mode voltage Vcom).

A driver control unit DCU may respectively transmit first and second setting signals (also referred to as driver settings) to the first output driver SAMPH and the second output driver SAMPL. The first setting signal and the second setting signal may be generated from different signal sources and/or have different driver settings. Thus, the first setting signal and the second setting signal may be independently controlled. For example, when the second setting signal received by the second output driver SAMPL remains unchanged, the first setting signal received by the first output driver SAMPH may be adjusted. In another implementation, when the first setting signal received by the first output driver SAMPH remains unchanged, the second setting signal received by the second output driver SAMPL may be adjusted.

The method according to the present example embodiment may include: detecting a positive polarity effective voltage and a negative polarity effective voltage of a display panel (operation S1); adjusting a driver setting of at least one of the first output driver and the second output driver based on the positive polarity effective voltage and the negative polarity effective voltage, to change magnitudes of the positive polarity effective voltage and/or the negative polarity effective voltage (operation S2); and when absolute values of the positive polarity effective voltage and the negative polarity effective voltage relative to a common mode voltage (Vcom) are substantially equal, obtaining an adjusted driver setting and applying the adjusted driver setting to the at least one of the first output driver and the second output driver (operation S3).

The positive polarity effective voltage and/or the negative polarity effective voltage of the display panel means a positive polarity voltage and a negative polarity voltage received by liquid crystal cells and liquid crystal molecules in pixels in the display panel, wherein the liquid crystal molecules may be rotated to a specific angle based on the effective voltages and the common mode voltage Vcom, so that an image may be displayed.

In an implementation, in operation S1, when the substantially same driver settings are input to the first output driver and the second output driver, the positive polarity effective voltage and the negative polarity effective voltage of the display panel may be detected.

In another implementation, in operation S1, when the same driver settings are input to the first output driver and the second output driver corresponding to a portion of the pixels in the display panel, the positive polarity effective voltage and the negative polarity effective voltage received by the liquid crystal cells in the portion of the pixels may be detected as a positive polarity effective voltage and a negative polarity effective voltage of the display panel. The number and positions of detected pixels in the display panel may be varied.

In an implementation, in operation S2, the driver setting of only one of the first output driver and the second output driver may be adjusted to change a magnitude of the positive polarity effective voltage or the negative polarity effective voltage. In another implementation, the driver settings of the first output driver and the second output driver may be adjusted simultaneously and independently to change magnitudes of the positive polarity effective voltage and the negative polarity effective voltage.

In an implementation, in operation S3, the adjusted driver setting is applied to the first output driver and/or the second output driver corresponding to each pixel in the display panel.

In the above operations S1 to S3 and embodiments thereof, the term “substantially same” may mean that a numerical value is controlled to be in the same size within an allowable deviation range, or may mean that a numerical value is controlled within a desired range.

Different display panels may have different driver settings.

By way of background, when a line time is short, even if a source driver outputs positive and negative polarity data voltages with substantially same gray scale, absolute values of corresponding positive and negative polarity effective voltages relative to a common mode voltage may be different due to different conduction currents of transistors (TFTs). Thus, liquid crystal molecules in a pixel may also be driven differently, which may result in an image being actually displayed in different gray levels.

In the present example embodiment, magnitudes of a positive polarity effective voltage and/or a negative polarity effective voltage may be changed by adjusting a driver setting of at least one of the first output driver SAMPH and the second output driver SAMPL, so that absolute values of the adjusted positive and negative polarity effective voltages relative to a common mode voltage are substantially equal. This may mitigate or eliminate an issue of an image being actually displayed in different gray levels.

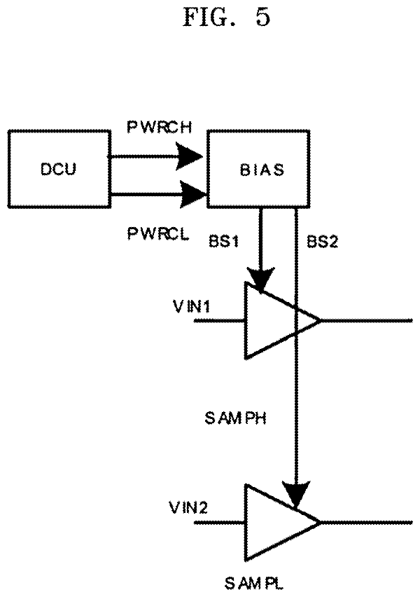

FIG. 5 is an example of a source driver according to an example embodiment. In FIG. 5, the same reference numerals as those of FIG. 3 denote the same elements, and thus some repeated descriptions thereof may be omitted.

The source driver in FIG. 5 includes the driver control unit DCU and a bias circuit BIAS between the driver control unit DCU and the output drivers. The driver settings of the first output driver SAMPH and the second output driver SAMPL may be adjusted by changing bias signals of the output drivers. Referring to FIG. 5, the first output driver SAMPH and the second output driver SAMPL may respectively receive a first bias signal BS1 and a second bias signal BS2 that are different from each other. For example, the first bias signal BS1 and the second bias signal BS2 may be generated from different bias signal sources and/or have different bias settings. The first bias signal BS1 and the second bias signal BS2 may be independently controlled. The first bias signal BS1 and the second bias signal BS2 may be bias currents or bias voltages.

The driver control unit DCU may transmit a first signal PWRCH and a second signal PWRCL to the bias circuit BIAS. The bias circuit may convert the first signal PWRCH into the first bias signal BS1 input to the first output driver SAMPH. The bias circuit may convert the second signal PWRCL into the second bias signal BS2 input to the second output driver SAMPL.

The bias circuit may be composed of transistors of different sizes according to operating characteristics of the transistors, in order to provide a bias signal for the circuit.

According to the present example embodiment, a method may include: detecting a positive polarity effective voltage and a negative polarity effective voltage of a display panel; adjusting at least one of the first signal PWRCH and the second signal PWRCL based on the positive polarity effective voltage and the negative polarity effective voltage, to adjust the bias signal input to the corresponding output driver and then to change magnitudes of the positive polarity effective voltage and/or the negative polarity effective voltage; and when absolute values of the positive polarity effective voltage and the negative polarity effective voltage relative to the common mode voltage are substantially equal, obtaining the adjusted at least one of the first signal PWRCH and the second signal PWRCL and applying it to the first output driver and/or the second output driver.

In the present example embodiment, the second input signal VIN2 has a polarity opposite to that of the first input signal VIN1, and the first input signal VIN1 and the second input signal VIN2 respectively correspond to the first data voltage and the second data voltage of substantially the same gray scale. In an implementation, when the substantially same first and second signals PWRCH and PWRCL are input to the first output driver and the second output driver, the positive polarity effective voltage and the negative polarity effective voltage of the display panel are detected.

In an implementation, the positive polarity effective voltage and the negative polarity effective voltage received by liquid crystal cells in a portion of pixels in the display panel may be respectively detected as a positive polarity effective voltage and a negative polarity effective voltage of the display panel.

In an implementation, the adjusted first and/or second signal PWRCH and/or PWRCL (or referred to as the bias signal) is applied to the first output driver and/or the second output driver corresponding to each pixel in the display panel.

In an implementation, the source driver includes an output switch multiplexer and a charge sharing module connected between the first and second output drivers SAMPH and SAMPL and the display panel 400 (see FIG. 3).

For different display panels, different adjusted signals PWRCH and PWRCL may be used.

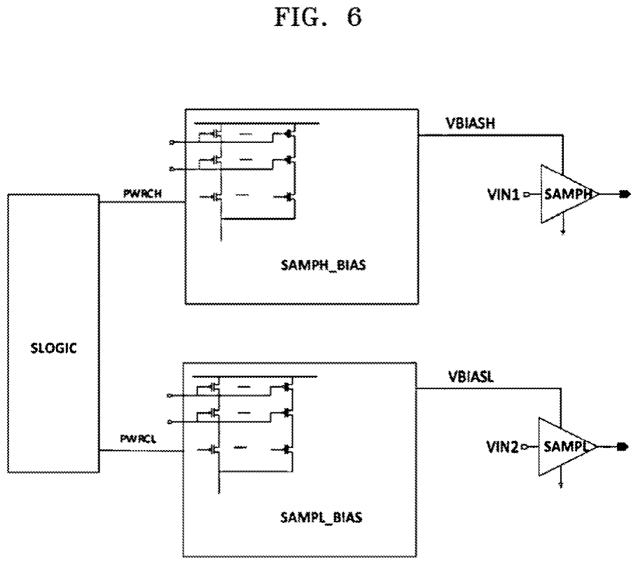

FIG. 6 is an example of the source driver of FIG. 5. In FIG. 6, the same reference numerals as those of FIG. 5 denote the same elements, and thus some repeated descriptions thereof may be omitted.

The source driver may include a logic circuit SLOGIC, a first output driver bias circuit SAMPH_BIAS, a second output driver bias circuit SAMPL_BIAS, a first output driver SAMPH, and a second output driver SAMPL.

The first output driver bias circuit SAMPH_BIAS and the second output driver bias circuit SAMPL_BIAS are examples of bias circuits which are analog circuits. FIG. 6 shows a first output driver bias circuit SAMPH_BIAS and a second output driver bias circuit SAMPL_BIAS composed of transistors of different sizes.

The logic circuit SLOGIC may transmit a signal PWRCH to the first output driver bias circuit SAMPH_BIAS, and the first output driver bias circuit SAMPH_BIAS may convert the signal PWRCH into a bias voltage VBIASH. The first output driver SAMPH may receive the bias voltage VBIASH.

The logic circuit SLOGIC may transmit a signal PWRCL to the second output driver bias circuit SAMPL_BIAS, and the second output driver bias circuit SAMPL_BIAS may convert the signal PWRCL into a bias voltage VBIASL. The first output driver SAMPL may receive the bias voltage VBIASL.

The signals PWRCH and PWRCL may be set through a configuration of a transmission interface protocol or may have other implementations for the source driver.

According to the present example embodiment, a method may include: detecting a positive polarity effective voltage and a negative polarity effective voltage of a display panel; adjusting at least one of signals PWRCH and PWRCL based on the positive polarity effective voltage and the negative polarity effective voltage, to change magnitudes of the positive polarity effective voltage and/or the negative polarity effective voltage; and when absolute values of the positive polarity effective voltage and the negative polarity effective voltage relative to a common mode voltage are substantially equal, obtaining the adjusted at least one of the signals PWRCH and PWRCL and changing the signals PWRCH and/or PWRCL in a source driver to the corresponding adjusted at least one of the signal PWRCH and PWRCL.

In an implementation, when the substantially same signals PWRCH and PWRCL are input, the effective voltage of the positive polarity and the effective voltage of the negative polarity of the display panel may be detected.

In an implementation, the positive polarity effective voltage and the negative polarity effective voltage received by liquid crystal cells in a portion of pixels in the display panel may be detected as a positive polarity effective voltage and a negative polarity effective voltage of the display panel.

In an implementation, the adjusted signals PWRCH and/or PWRCL may be applied to the first output driver and the second output driver corresponding to each pixel in the display panel.

When the negative polarity effective voltage of the display panel has a magnitude which may be greater than that of the positive polarity effective voltage, the method may improve a difference between positive and negative polarities of the display panel by operations that include: detecting a positive polarity effective voltage and a negative polarity effective voltage of the display panel, in the case that signals PWRCH and PWRCL are set to be substantially same; based on the positive polarity effective voltage and the negative polarity effective voltage, adjusting the signal PWRCH such that a bias voltage of the first output driver is adjusted, so as to increase the positive polarity effective voltage such that an absolute value of the positive polarity effective voltage relative to a common mode voltage is substantially the same as an absolute value of the negative polarity effective voltage relative to the common mode voltage; and when the absolute values of the positive and negative polarity effective voltages relative to the common mode voltage are substantially equal, obtaining the adjusted signal PWRCH and changing the signals PWRCH of all the first output drivers in the source driver to the adjusted signal PWRCH.

In another implementation, the signal PWRCL may be adjusted to adjust the bias voltage of the second output driver. When the absolute value of the negative polarity effective voltage relative to the common mode voltage is reduced until it is substantially the same as the absolute value of the positive polarity effective voltage relative to the common mode voltage, the adjusted signal PWRCL may be obtained and the signals PWRCL of all the second output drivers in the source driver may be changed to the adjusted signal PWRCL.

In another implementation, the absolute value of the negative polarity effective voltage relative to the common mode voltage may be made substantially the same as the absolute value of the positive polarity effective voltage relative to the common mode voltage by adjusting the bias current, instead of the bias voltage, of the corresponding output driver.

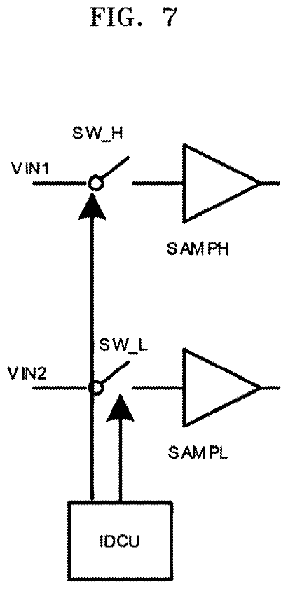

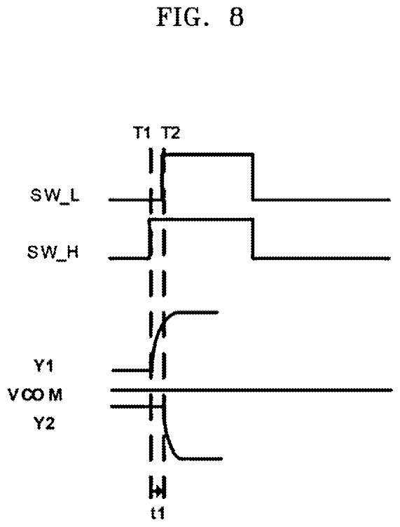

FIG. 7 is an example embodiment of a source driver according to another example embodiment. FIG. 8 is a waveform diagram of an output driver driving a pixel on a display panel. In FIGS. 7 and 8, the same reference numerals as those of FIGS. 3 and 4 denote the same elements, and thus some repetitive descriptions thereof may be omitted.

Referring to FIG. 7, a source driver may include an input delay control unit IDCU, a first switch SW_H, a second switch SW_L, a first output driver SAMPH, and a second output driver SAMPL. The first switch SW_H and the second switch SW_L are connected to input terminals of the first output driver and the second output driver, respectively.

The input delay control unit IDCU may generate a delay signal to control timing of turning on/off the first switch SW_H and the second switch SW_L. The input delay control unit IDCU may control the first output driver SAMPH to output a first data voltage to a pixel at a first time T1 in an image frame through the first switch SW_H, and control the second output driver SAMPL to output a second data voltage to the pixel at a second time T2 in another image frame through the second switch SW_L. In the present example embodiment, the second data voltage has a polarity opposite to that of the first data voltage, and an absolute value of the second data voltage with respect to a common mode voltage is the same as an absolute value of the first data voltage with respect to the common mode voltage. The input delay control unit IDCU may control charging time of liquid crystal cells of a pixel by controlling turn-on timing of the first switch SW_H and the second switch SW_L, thereby changing effective voltages.

According to the present example embodiment, a method may include: detecting a positive polarity effective voltage and a negative polarity effective voltage of a display panel; based on the positive polarity effective voltage and the negative polarity effective voltage, adjusting at least one of the first time T1 and the second time T2 such that the at least one of the first time T1 and the second time T2 is offset by a first period, thereby changing magnitudes of the positive polarity effective voltage and/or the negative polarity effective voltage; and when absolute values of the positive and negative polarity effective voltages relative to a common mode voltage is substantially equal, obtaining the first period corresponding to the at least one of the first time T1 and the second time T2 and applying the obtained first period to the first output driver SAMPH and/or the second output driver SAMPL of all pixels.

In an implementation, when there is no relative delay between the second time T2 and the first time T1 or when the first time T1 and the second time T2 have the substantially same delay, the positive polarity effective voltage and the negative polarity effective voltage of the display panel may be detected.

When the negative polarity effective voltage of the display panel has a magnitude greater than that of the positive polarity effective voltage, the second time T2 may be delayed by the first period (for example, period t1 in FIG. 8), so that the absolute value of the negative polarity effective voltage relative to the common mode voltage is reduced to the same as the absolute value of the positive polarity effective voltage relative to the common mode voltage. Referring to FIGS. 7 and 8, the input delay control unit IDCU may control the first output driver SAMPH to output the first data voltage to a pixel at the first time T1 in an image frame, and the positive polarity effective voltage Y1 of the pixel may be detected. Then, the input delay control unit IDCU may generate the delayed signal so that the second output driver SAMPL outputs the second data voltage to the pixel at the second time T2 delayed by the period t1 in another image frame, and the negative polarity effective voltage Y2 of the pixel may be detected. As a result, when the second data voltage is transmitted, the charging time of the liquid crystal cells in the corresponding pixel may be shorter than the charging time during which the first data voltage is transmitted, so that the absolute value of the negative polarity effective voltage relative to the common mode voltage is reduced to the same as absolute value of the positive polarity effective voltage relative to the common mode voltage.

Therefore, if the positive polarity data voltage and the negative polarity data voltage of the approximately same gray scale are applied, and the positive polarity effective voltage and the negative polarity effective voltage with respect to the common mode voltage are different in absolute value, then the second time may be delayed by the period t1, so that the positive polarity effective voltage and the negative polarity effective voltage are changed to be approximately same in absolute value relative to the common mode voltage. In this way, the positive polarity data voltage and the negative polarity data voltage of the approximately same gray scale may provide substantially the same effect (i.e., the gray scales of the actual displayed images thereof are the same).

In an implementation, the timing of the delay signal generated by the input delay control unit IDCU may be set through a configuration of a transmission interface protocol.

In an implementation, the positive and negative polarity effective voltages received by the liquid crystal cells of a portion of the pixels of the display panel may be detected as positive and negative polarity effective voltages of the display panel. Based on the positive polarity effective voltage and the negative polarity effective voltage, at least one of the first time T1 and the second time T2 of the portion pixels may be adjusted.

In another implementation, the first time T1 may be advanced, e.g., by the period t1, to increase the absolute value of the positive polarity effective voltage relative to the common mode voltage up to be substantially the same as the absolute value of the negative polarity effective voltage relative to the common mode voltage.

In another implementation, if the magnitude of the negative polarity effective voltage of the display panel is smaller than that of the positive polarity effective voltage, then the first time T1 may be delayed by a certain period or the second time T2 may be advanced by a certain period, such that the negative and positive polarity effective voltages relative to the common mode voltage are approximately same in absolute value.

By way of summation and review, a line time may become shorter with increased screen resolution and size of a display panel. Therefore, turn-on currents of thin film transistors (TFTs) in pixels may be increased. The thin film transistors in the pixels may have different turn-on currents for different data voltages. When the thin film transistors in the pixels are applied with positive and negative polarity data voltages having a substantially same gray scale, they may have different turn-on currents due to differences in absolute values of the voltages, such that the positive and negative polarity data voltages of the pixels do not have equal relative values, which may cause display issues such as image sticking, flicker, etc.

As described above, embodiments relate to a method for compensating for a difference between positive and negative electric performances of a display panel by independently controlling drivers outputting positive and negative polarities.

Embodiments may provide a display and a method of driving the same that reduce or mitigate display issues such as image sticking, flicker, etc., by adjusting driver settings of a positive polarity output driver and a negative polarity output driver in a source driver. Embodiments may provide a source driver and a method for compensating for a difference between positive and negative polarities of a display panel.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

1. A method for compensating for a difference between positive and negative polarities of a display panel, the display panel being electrically connected to a source driver, the source driver including a first output driver and a second output driver alternately connected to a same data line in the display panel, the method comprising:
detecting a positive polarity effective voltage and a negative polarity effective voltage of the display panel;
adjusting a driver setting of at least one of the first output driver and the second output driver based on the positive polarity effective voltage and the negative polarity effective voltage, so as to change magnitudes of the positive polarity effective voltage and/or the negative polarity effective voltage;
determining whether the positive polarity effective voltage and the negative polarity effective voltage relative to a common mode voltage are identical in absolute value, and
when the positive polarity effective voltage and the negative polarity effective voltage relative to the common mode voltage are identical in absolute value, obtaining an adjusted driver setting and applying the adjusted driver setting to the at least one of the first output driver and the second output driver, wherein each of the first output driver and the second output driver is a programmable and drivable buffer.

2. The method as claimed in claim 1, wherein the detecting of the positive polarity effective voltage and the negative polarity effective voltage of the display panel includes: detecting the positive polarity effective voltage and the negative polarity effective voltage of the display panel when same driver settings are input to the first output driver and the second output driver.

3. The method as claimed in claim 2, wherein the first output driver and the second output driver are arranged in multiple pairs, and each pair of the first output driver and the second output driver is connected to a respective data line in the display panel, so that each of a plurality of pixels in the display panel is alternately driven by each pair of the first output driver and the second output driver,
wherein the detecting of the positive polarity effective voltage and the negative polarity effective voltage of the display panel further includes: detecting the positive polarity effective voltage and the negative polarity effective voltage received by liquid crystal cells in a portion of the plurality of pixels in the display panel as the positive polarity effective voltage and the negative polarity effective voltage of the display panel, and
wherein the applying of the adjusted driver setting to the at least one of the first output driver and the second output driver includes: applying the adjusted driver setting to the at least one of the first output driver and the second output driver corresponding to each of the plurality of pixels.

4. The method as claimed in claim 2, wherein the source driver further includes:
a driver control unit having a logic circuit configured to generate a first signal and a second signal; and
a bias circuit between the driver control unit and the first and second output drivers, the bias circuit converting the first signal and the second signal transmitted by the driver control unit into a first bias signal input to the first output driver and a second bias signal input to the second output driver, respectively, and
wherein the adjusting of the driver setting of the at least one of the first output driver and the second output driver includes: adjusting at least one of the first signal and the second signal by the logic circuit, so as to adjust the corresponding first and/or second bias signals.

5. The method as claimed in claim 4, wherein the first bias signal and the second bias signal are bias currents or bias voltages.

6. The method as claimed in claim 5, wherein the bias circuit includes:
a first bias circuit from which the first output driver receives the first bias signal; and
a second bias circuit from which the second output driver receives the second bias signal, the second bias circuit being different from the first bias circuit.

7. The method as claimed in claim 2, wherein the source driver further includes a first switch and a second switch respectively connected to an input terminal of the first output driver and an input terminal of the second output driver, and an input delay control unit for controlling on and off states of the first switch and the second switch,
wherein the input delay control unit controls the first output driver to output a first data voltage to a pixel of the display panel at a first time, and controls the second output driver to output a second data voltage to the pixel at a second time, the second data voltage having a polarity opposite to that of the first data voltage, and an absolute value of the second data voltage with respect to a common mode voltage being the same as an absolute value of the first data voltage with respect to the common mode voltage, and
wherein the adjusting of the driver setting of the at least one of the first output driver and the second output driver includes: adjusting at least one of the first time and the second time so that the at least one of the first time and the second time is offset by a first period, and a magnitude of the positive polarity effective voltage and/or the negative polarity effective voltage is changed.

8. The method as claimed in claim 7, wherein the adjusting of the at least one of the first time and the second time includes: adjusting only the second time so that the second time is delayed by the first period.

9. The method as claimed in claim 7, wherein the adjusting of the at least one of the first time and the second time includes: adjusting only the first time so that the first time is advanced by the first period.

10. The method as claimed in claim 1, wherein for different display panels, different adjusted driver settings are used.

11. A source driver for driving a display panel, the source driver comprising:
a first output driver and a second output driver corresponding to each of a plurality of pixels included in the display panel, each of the first output driver and the second output driver being a programmable and drivable buffer; and
a driver control unit having a logic circuit configured to
determine whether a positive polarity effective voltage and a negative polarity effective voltage relative to a common mode voltage are identical in absolute value, and adjust a driver setting of at least one of the first output driver and the second output driver based on the positive polarity effective voltage and the negative polarity effective voltage, so as to change magnitudes of the positive polarity effective voltage and/or the negative polarity effective voltage,
wherein the driver control unit is configured to apply an adjusted driver setting to the at least one of the first output driver and the second output driver, and
wherein the adjusted driver setting is obtained when the driver control unit determines that the positive polarity effective voltage and the negative polarity effective voltage relative to a common mode voltage are identical in absolute value.
